(19) United States
(12) Patent Application Publication
(10) Pub. No.: US 2025/0173139 A1
(43) Pub. Date: May 29, 2025

(54) WEARABLE DEVICE, CONTROL METHOD, AND RECORDING MEDIUM

(71) Applicant: CASIO COMPUTER CO., LTD., Tokyo (JP)

(72) Inventor: Shuhei UCHIDA, Tokyo (JP)

(73) Assignee: CASIO COMPUTER CO., LTD., Tokyo (JP)

(21) Appl. No.: 18/960,111

(22) Filed: Nov. 26, 2024

(30) Foreign Application Priority Data
Nov. 29, 2023 (JP) 2023-202123

(51) Int. Cl. G06F 8/65

(52) U.S. Cl. CPC G06F 8/65

(57) ABSTRACT

A wearable device includes a processor, memory, a sensor that detects whether an own device is in a state of being carried with a user, and a communication circuit that communicates with an external device. The memory stores at least updatable software. The processor is configured to execute the updatable software, and in a case where the sensor detects that the own device is not in a state of being carried with the user, make processing related to update of the updatable software executable in cooperation with the external device through the communication circuit.

### CROSS-REFERENCE TO RELATED APPLICATION

This application is based on and claims the benefit of priority to Japanese Patent Application No. 2023-202123 filed on 29 Nov. 2023, the entire contents of which are incorporated herein by reference.

### BACKGROUND

### Field

The present disclosure relates to a wearable device, a control method, and a recording medium.

### Related Art

Various wearable devices such as wristwatch-type smart watches that are used by being worn on a human body have been developed and used. For example, as disclosed in Japanese Unexamined Patent Application, Publication No. 2022-103945, software such as the firmware implemented in a wearable device is updated as necessary for the purpose of improving the functions and security of the device. In general, since the use of the functions of the wearable device is restricted during the update processing, there are cases where a measure is taken to notify the user of the wearable device that the software can be updated by some means prior to the execution of the processing related to the update.

### SUMMARY

According to an aspect of the present disclosure, a wearable device includes: a processor; memory; a sensor that detects whether an own device is in a state of being carried with a user; and a communication circuit that communicates with an external device, in which the memory stores at least updatable software, and the processor is configured to execute the updatable software, and in a case where the sensor detects that the own device is not in a state of being carried with the user, make processing related to update of the updatable software executable in cooperation with the external device through the communication circuit.

### BRIEF DESCRIPTION OF THE DRAWINGS

FIG. 1 is a schematic front view of a mobile wireless device according to an embodiment of the present disclosure;

FIG. 2 is a schematic diagram showing a hardware configuration example of the mobile wireless device according to the embodiment of the present disclosure;

FIG. 3 is a schematic diagram showing functional blocks of the mobile wireless device according to the embodiment of the present disclosure;

FIG. 4 is a flowchart illustrating control software update notification processing according to one embodiment of the present disclosure; and

FIG. 5 is a diagram showing an example of a control software update notification screen according to the embodiment of the present disclosure.

### DETAILED DESCRIPTION OF EMBODIMENTS

Hereinafter, embodiments of the present disclosure will be described with reference to the accompanying drawings.

### Configuration of Mobile Wireless Device

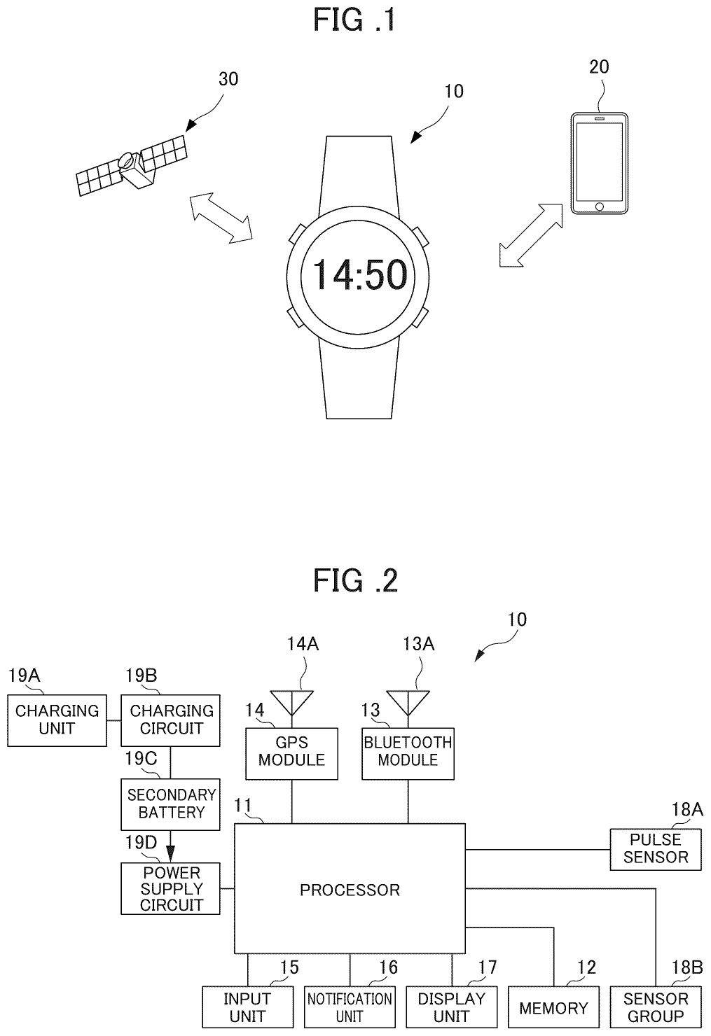

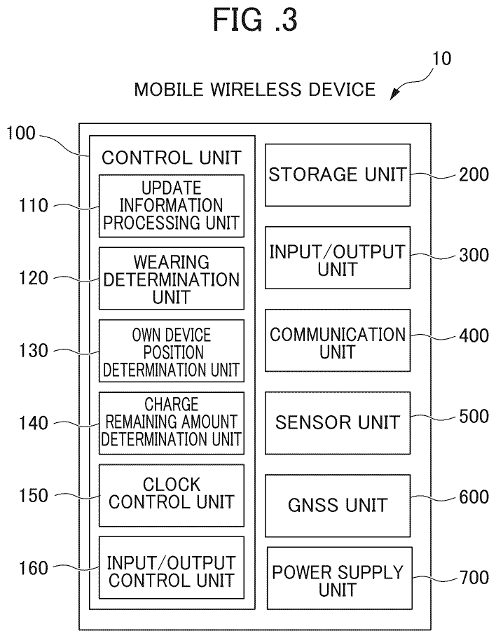

First, a configuration of a mobile wireless device serving as a wearable device according to the present embodiment will be described with reference to FIGS. 1 to 3. FIG. 1 is a schematic front view of a mobile wireless device according to the present embodiment, and FIGS. 2 and 3 are each diagrams showing an example of a hardware configuration and an example of functional blocks of the mobile wireless device of FIG. 1. The mobile wireless device 10 of the present embodiment is configured as a wristwatch-type device used by a user wearing it on the forearm. The mobile wireless device 10 has a time display, a standard time display such as an alarm and a timer, and a time counting function. In addition, the mobile wireless device 10 may be provided with various measurement functions including temperature measurement, barometric pressure measurement, heart rate measurement, and activity amount measurement such as step count measurement. Alternatively, the mobile wireless device 10 may be an electronic device such as an activity meter which does not include a time display function as a clock.

As shown in FIG. 1, the mobile wireless device 10 communicates with another communication terminal such as a smartphone 20 by wireless communication such as Bluetooth (registered trademark) Low Energy (BLE) to receive information related to control software update, update data, and the like from the other communication terminal. The control software is software such as an operating system (OS), firmware, and drivers of various devices for realizing the functions of the wearable device. The update is also referred to as “updating”. The mobile wireless device 10 may also be communicably connected to an external device such as a management server for managing the operation and functions of the mobile wireless device 10 via a wireless LAN, the Internet, or a mobile communication network by providing a Wi-Fi communication module or a mobile communication module. In this case, the information related to the control software update, the update data, and the like can be received from the management server.

As shown in FIG. 1, the mobile wireless device 10 is also configured to receive a signal (hereinafter, referred to as a “satellite signal”) transmitted from a positioning satellite 30 such as a global positioning system (GPS) satellite, calculate the position of its own device based on satellite signals received from a plurality of positioning satellites 30, and retain the position as its own device positional information.

### Hardware Configuration Example of Mobile Wireless Device 10

Next, a hardware configuration example of the mobile wireless device 10 according to the present embodiment will be described with reference to FIG. 2.

The mobile wireless device 10 illustrated in FIG. 2 is configured as a wristwatch-type device as described with reference to FIG. 1, and includes a processor 11, memory 12, a Bluetooth module 13, a Bluetooth antenna 13A, a GPS module 14, a GPS antenna 14A, an input unit 15, a notification unit 16, a display unit 17, a pulse sensor 18A, a sensor group 18B, a charging unit 19A, a charging circuit 19B, a secondary battery 19C, and a power supply circuit 19D, as main components related to the present disclosure.

The processor 11 has a function of performing processing such as various calculations and controls necessary for the operation of the mobile wireless device 10, and is mounted as an IC chip or the like. The memory 12 is a storage device that provides a storage area for storing various programs to be executed by the processor and data to be used when the program is executed, and is configured as various memory chips including, for example, nonvolatile memory and volatile memory.

The Bluetooth module 13 is configured by a wireless communication chip for performing wireless communication conforming to a communication standard such as Bluetooth Low Energy (BLE). The Bluetooth antenna 13A is an antenna used for transmission and reception of wireless communication performed by the Bluetooth module 13, and is an antenna of an appropriate type such as a monopole antenna. In addition, the communication module is not limited to the Bluetooth module 13, and a communication module that enables wireless communication based on another communication standard such as Wireless Fidelity (Wi-Fi) or Near Field Communication (NFC) may be employed.

The GPS module 14 has a function of acquiring time information and positional information from satellite signals received from positioning satellites such as GPS satellites. The GPS antenna 14A is an antenna of an appropriate type suitable for receiving weak satellite signals and, for example, a patch antenna can be used.

The input unit 15 is an input device for giving an operation instruction to each unit of the mobile wireless device 10, and includes operation buttons, a touch panel, and the like provided on the main body of the mobile wireless device 10. The notification unit 16 is a device such as a speaker, a buzzer, or a vibration element provided to transmit output information from the mobile wireless device 10 to the user by voice, vibration, or the like. The display unit 17 is a device for displaying time and other pieces of information, and includes a liquid crystal panel, an organic EL panel, and the like.

The pulse sensor 18A is, for example, a device such as an infrared sensor or a pressure sensor provided on a surface in contact with the body surface of the user in a case where the mobile wireless device 10 is worn, which detects the pulse of the user based on the blood flow fluctuation, and detects whether or not the mobile wireless device 10 is in a state of being carried with the user. For example, in a case where the pulse sensor 18A determines that there is a pulse, it is determined that the mobile wireless device 10 is worn by the user and is in use, that is, is carried with the user. The term “carried with the user” includes not only the action of wearing the mobile wireless device 10 on a body part of the user such as the wrist, but also the general action of carrying the user together with the user in the form of a decorative article such as a necklace or a pendant, or by attaching the mobile wireless device to a bracelet such as clothing or a bag.

The sensor group 18B includes, in addition to the pulse sensor 18A, for example, an acceleration sensor for detecting a swing of the arm of the user, a proximity sensor for detecting that the main body is in proximity to the body surface of the user, and the like. Also in this case, it may be determined that the mobile wireless device 10 is worn by the user and is in use, that is, is carried with the user. In addition, as a sensor for detecting whether the mobile wireless device 10 is indoors or outdoors, for example, an output charging current sensor of a secondary battery charging solar cell that is a driving source of the mobile wireless device 10, an illuminance sensor that senses external light, an ultraviolet sensor, or the like may be provided. Which of these sensors is used to detect the wearing state of the user may be determined according to the design specification of the mobile wireless device 10. In addition, the sensor group 18B may be provided with a geomagnetic sensor, a pressure sensor, a temperature sensor, and the like for collecting information related to the surrounding environment of the mobile wireless device 10.

The charging unit 19A supplies electric power to a power supply system of the mobile wireless device 10 from the outside, and corresponds to a charging cable connection terminal for receiving electric power supplied from an external power supply, a solar cell that is provided on a dial surface or the like and converts light energy received from external light such as sunlight into electric power, and the like. The charging circuit 19B has a function of an adjustment circuit that adjusts the current from the charging unit 19A according to the charge/discharge state of the secondary battery 19C described later. The secondary battery 19C is a rechargeable secondary battery such as a lithium secondary battery for supplying power to the mobile wireless device 10. The power supply circuit 19D is a circuit including a power supply IC or the like for converting electric power from the secondary battery 19C into a required voltage, and supplying the voltage to each unit in the mobile wireless device 10.

### Functional Configuration Example of Mobile Wireless Device 10

Next, each functional block included in the mobile wireless device 10 of the present embodiment will be described with reference to FIG. 3. As illustrated in FIG. 3, the mobile wireless device 10 includes a control unit 100, a storage unit 200, an input/output unit 300, a communication unit 400, a sensor unit 500, a GNSS (Global Navigation Satellite System) unit 600, and a power supply unit 700.

The processor 11 reads and executes various programs stored in the storage unit 200, which will be described later, so that the control unit 100 realizes processing of various calculations, controls, etc. necessary for the operation of the mobile wireless device 10.

In order to realize the functions of the control unit 100, the storage unit 200 stores various programs executed by the processor 11 and data used at the time of execution of the programs, and functions as a storage area that provides a work area temporarily used in performing various processing.

The input/output unit 300 includes the input unit 15, the notification unit 16, and the display unit 17 in the hardware configuration example of FIG. 2.

The communication unit 400 includes a communication module such as the Bluetooth module 13 in FIG. 2, and has a function of controlling communication performed by the mobile wireless device 10 with another communication terminal such as the smartphone 20 or another external device such as a management server for the mobile wireless device 10.

The sensor unit 500 has a function of providing data for determining whether or not the user of the mobile wireless device 10 wears or carries the mobile wireless device 10, and data for determining whether or not the mobile wireless device 10 is indoors in a building or outdoors, using the pulse sensor 18A and the sensor group 18B in FIG. 2.

The GNSS unit 600 realizes a function of acquiring time information and positional information from satellite signals by using the GPS module 14 in FIG. 2.

The power supply unit 700 realizes a function of supplying the necessary power to each unit of the mobile wireless device 10 by the charging unit 19A, the charging circuit 19B, the secondary battery 19C, and the power supply circuit 19D in FIG. 2.

Next, functions realized by the control unit 100 of the mobile wireless device 10 will be described. As illustrated in FIG. 3, the control unit 100 of the present embodiment includes an update information processing unit 110, a wearing determination unit 120, an own device position determination unit 130, a remaining charge amount determination unit 140, a clock control unit 150, and an input/output control unit 160. The functional units provided in the control unit 100 are not limited thereto, and may be appropriately changed or added according to the functions provided in the mobile wireless device 10.

The update information processing unit 110 continuously monitors the information related to the update of the control software received from the mobile terminal such as the smartphone 20 through the communication unit 400, and determines whether or not there is update data of the control software to be applied to its own device. Further, as described later, when the requirement for notifying the update information is completed, the display unit 17 or the like is made to output the update information.

The wearing determination unit 120 has a function of determining whether or not the mobile wireless device 10 is worn on the arm of the user or is carried with the user based on the output data from the sensor unit 500, thereby detecting whether or not the device itself is worn on the human body or carried with the human. For example, in a case where the pulse sensor 18A outputs data indicating the pulse based on the blood flow of the arm of the user, it is determined that the mobile wireless device 10 is worn on the arm of the user. Alternatively, in a case where the output data from the acceleration sensor included in the sensor group 18B indicates a predetermined temporal variation, or in a case where the proximity sensor outputs data indicating proximity to an object, it is determined that the mobile wireless device 10 is worn on or carried by the user. In a case where the output data from the sensor unit 500 is not detected, the wearing determination unit 120 determines that the mobile wireless device 10 is not worn on the arm of the user or carried with the user. In general, the mobile wireless device 10 including the sensor unit 500 is used during a workout such as running or walking, and the user often checks a pulse value, a map, or the like displayed on the display unit 17 while the mobile wireless device 10 is worn. Therefore, since it can be estimated that the information indicating that it is determined that the mobile wireless device 10 is not worn by the user is a state in which the user is not using the mobile wireless device 10 or not a state in which the user is looking at the display unit 17 of the mobile wireless device 10, it is determined that the usability is not impaired even if the notification of the control software update is performed. In addition, in a case where the notification of the control software update of the mobile wireless device 10 is performed in a state in which the user is not wearing the device, the notification may be performed on the display unit of the smartphone 20, and on the other hand, in a case where the notification is displayed on the display unit 17 of the mobile wireless device 10, the notification may be performed by generating a sound or a vibration by a device such as a speaker, a buzzer, or a vibration element provided in the notification unit 16 in order to alert the user.

The own device position determination unit 130 determines whether or not the own device is in a state in which the notification of the control software update is permitted based on the positional information of the own device received from the GNSS unit 600. Specifically, for example, in a case where it is determined that the position of the own device received from the GNSS unit 600 is separated by a predetermined distance (for example, a radius of 100 m from the position of the user's home) or more with respect to the positional information indicating the position of the user's home which was set and registered in advance in the mobile wireless device 10, it can be determined that the user is away from the user's home and is at a place outside the home. A certain amount of time is required to execute the control software update, and a predetermined remaining charge amount of the secondary battery of the mobile wireless device 10 is also required. During a workout such as running, it is important to confirm the display content in real time. In consideration of such circumstances, in a case where it is determined that the user is at a place outside the home, it is not realistic to immediately respond to the notification that the control software update is available to the user, and it is assumed that the user would feel bothered. Therefore, in a case where it is determined that the position of the own device is away from the home by a distance farther than the predetermined distance from the home, the notification of the control software update is not performed. In addition, the positional information registered in advance is not limited to the user's home, and may be an arbitrary place designated by the user, such as a place conforming to the user's home, a school, or a workplace. It is preferable that the GNSS unit 600 is operated for a minimum required short time (required operation time) for acquiring the positional information at a timing in a case where the position determination by the own device position determination unit 130 is performed. That is, in order to determine whether or not the position (positional information) of the own device is within a predetermined position range set in advance, it is sufficient that the minimum positional information (for example, coordinates of one point) of the own device can be acquired after the start of the operation, and the GNSS unit 600 may acquire the coordinates of at least one point or may terminate the acquisition of the positional information (turn off the operation) after the operation is performed for the minimum operation time. Alternatively, it is desirable to periodically operate at a minimum frequency (for example, at intervals of several minutes or several hours) in order to provide the own device position determination unit 130 with the positional information. These are for preventing the operation of the GNSS unit 600 from excessively consuming the power supply of the mobile wireless device 10, which is a wearable device generally having a large restriction on battery capacity (to suppress power consumption). In addition, it is also possible to determine whether the position of the own device is indoors in a building or outdoors by using an illuminance sensor, an ultraviolet sensor, or the like included in the sensor group 18B and, in a case where it is determined that the own device is indoors, it is possible to allow for the notification of the control software update because there is room for satisfying the reference required for the control software update with respect to the time required for the control software update and the remaining charge amount of the mobile wireless device 10. Similarly to the above, the GNSS unit 600 may determine whether the own device is indoors or outdoors. However, in a case of a building in which metal members are frequently used, an error of about several meters to several tens of meters may occur in the positional information of the own device due to the influence of electromagnetic waves from positioning satellites. Therefore, in a case where it is determined whether or not the own device is in a state in which the notification of control software update is permitted based on the positional information of the own device obtained by the GNSS unit 600, as described above, it is possible to provide a reliable determination by using the determination of comparing the positional information (within the predetermined position range) registered in advance with the positional information of the own device. That is, even indoors, if the error is about several tens of meters, it is possible to reliably determine whether or not the own device is within the predetermined position range, and it is possible to perform the notification of the control software update at an appropriate timing. Alternatively, it may be possible to detect that the time information of the mobile wireless device 10 is in a predetermined time slot, and to set, for example, a period from 1 a.m. to 5 a.m. as a time slot in which notification is permitted.

The remaining charge amount determination unit 140 has a function of estimating the remaining charge amount of the secondary battery 19C based on the terminal voltage measurement value or the charge/discharge current measurement value of the secondary battery received from the power supply unit 700. For example, in a case where it is determined that the estimated remaining charge amount is less than 80%, it is possible to perform control so that it is determined that the control software update cannot be executed without being charged and the notification of the control software update is not performed.

The clock control unit 150 controls the function of the mobile wireless device 10 as a timepiece. Specifically, the functions include time display control of the display unit 17 based on internally retained time data, switching of functions based on an operation input of a user's operation button, and correction of internal time data based on time data acquired through the communication unit 400 and the GNSS unit 600.

The input/output control unit 160 has a function of controlling transmission and reception of input/output data between the control unit 100 and the storage unit 200, the input/output unit 300, the communication unit 400, the sensor unit 500, the GNSS unit 600, and the power supply unit 700. For example, the input/output control unit 160 has a function of executing processing of passing information related to the control software update from the communication unit 400 to the update information processing unit 110, processing of passing positional information from the GNSS unit 600 to the own device position determination unit 130, processing of passing output data from the sensor unit 500 to the wearing determination unit 120, processing of passing information related to the remaining amount of charge of the secondary battery from the power supply unit 700 to the remaining charge amount determination unit 140, and the like.

### Control Software Update Notification Control Function of Present Embodiment

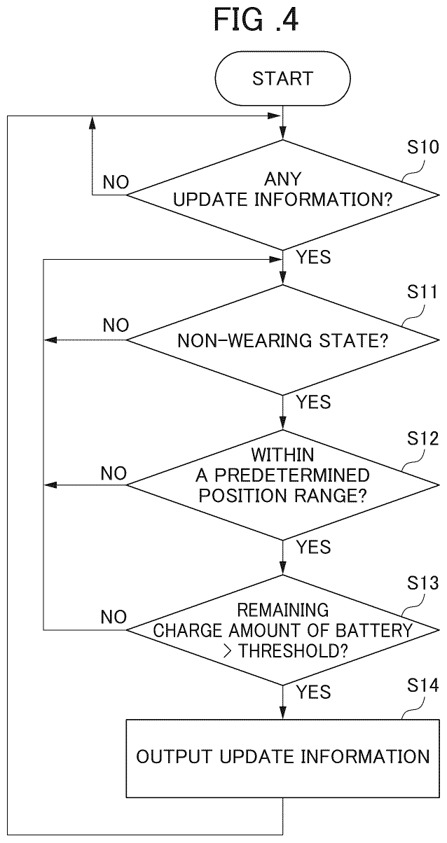

Next, the control software update notification control function in the mobile wireless device 10 of the present embodiment will be described. FIG. 4 is a flowchart showing an example of the flow of control software update notification control processing executed in the mobile wireless device 10 according to the present embodiment.

The control software update notification control processing illustrated in FIG. 4 is mainly executed by the update information processing unit 110, the wearing determination unit 120, the own device position determination unit 130, and the remaining charge amount determination unit 140 of the mobile wireless device 10.

The flow of the control software update notification control processing of FIG. 4 is continuously executed after the mobile wireless device 10 is powered on and the operation is started.

In Step S10, it is determined whether the update information processing unit 110 of the control unit 100 has received information indicating that the control software update is available from a mobile terminal such as the smartphone 20 or an external device such as a management server. A mobile terminal such as the smartphone 20 or an external device such as a management server periodically communicates with the mobile wireless device 10, checks whether there is new control software applicable to the mobile wireless device 10 by comparing the version of the control software operating in the mobile wireless device 10 with the version of the currently available control software, and notifies the mobile wireless device 10 in the case of there being an applicable update. In Step S10, the update information processing unit 110 determines whether there is an applicable update, waits for the processing if there is no applicable update (S10, NO), and determines that update information is received if it is determined that there is an update (S10, YES).

In Step S11, the wearing determination unit 120 determines whether the mobile wireless device 10 is worn by the user or carried with the user based on the output data from the sensor unit 500 including the pulse sensor 18A and the sensor group 18B. In a case where the wearing determination unit 120 determines that, based on the output data from the sensor unit 500, it is a state in which the user wears or carries the mobile wireless device 10, such as a state in which the pulse of the user is detected by the pulse sensor 18A or a state in which body motion such as the swing of the arm of the user is detected by the acceleration sensor (S11, NO), the wearing determination unit 120 maintains the standby state. In a case where the wearing determination unit 120 determines, based on the output data from the sensor unit 500, as being a non-wearing state (non-carried state) in which the user does not wear or carry the mobile wireless device 10 (S11, YES), the processing proceeds to Step S12.

In Step S12, the own device position determination unit 130 determines whether the mobile wireless device 10, which is the own device, is within a predetermined updateable position range. As described with respect to the own device position determination unit 130, the updateable position range indicates a geographical range in which certain conditions are considered to be satisfied, such as a range within a predetermined distance from the home position, in which a user who has received the updateable notification can perform a charging operation to secure a required remaining charge amount, and the mobile wireless device 10 can be kept in a non-use state for a certain period of time for the control software update processing. In a case where it is determined that the mobile wireless device 10, which is the own device, is not within the predetermined updateable position range (S12, NO), the own device position determination unit 130 maintains the standby state. In a case where it is determined that the own device is within the predetermined updateable range (S12, YES), the own device position determination unit 130 causes the processing to proceed to Step S13. As described with respect to the own device position determination unit 130, the operation of the GNSS unit 600 is limited to a minimum time necessary for the own device position determination unit 130 to perform the position determination.

In Step S13, the remaining charge amount determination unit 140 determines whether the update notification is possible based on the remaining charge amount of the secondary battery received from the power supply unit 700 of the mobile wireless device 10. In a case where it is determined that the remaining charge amount of the secondary battery is equal to or less than a predetermined threshold value, for example, equal to or less than 80% of full charge (S13, NO), the remaining charge amount determination unit 140 determines that the condition of the update notification is not completed and returns the processing to Step S11. In a case where it is determined that the remaining charge amount of the secondary battery exceeds the predetermined threshold value, for example, exceeds 80% of full charge (S13, YES), the remaining charge amount determination unit 140 causes the processing to proceed to Step S14.

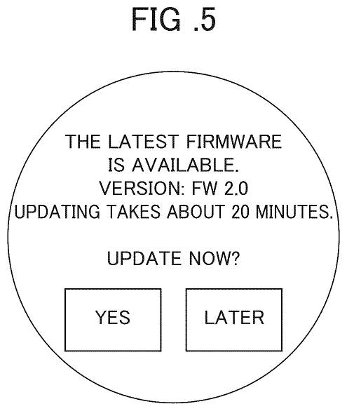

In Step S14, the update information processing unit 110 transmits information notifying that the control software update is possible to the user through the display unit 17 and the notification unit 16. FIG. 5 shows a display example of the notification screen displayed on the display unit 17 of the mobile wireless device 10. The notification screen displays a notification regarding the control software update in a case where all the requirements for executing the control software update are satisfied as described above. That is, in the example of the processing flow of FIG. 4, in a case where it is determined that the mobile wireless device 10 is in the non-wearing state or the non-carried state, the position of the mobile wireless device 10 is within the range in which the control software update can be executed, and the remaining charge amount of the secondary battery of the mobile wireless device 10 exceeds the predetermined threshold value, the notification related to the control software update is displayed. In FIG. 5, as an example of the display content, information relating to the control software update processing “The latest control software is available. Version: FW 2.0. Updating takes about 20 minutes.” is displayed. The information related to the control software update processing is generated based on data such as the model format, the operating control software version, and the latest communication speed of the mobile wireless device 10, which are acquired by a mobile terminal such as the smartphone 20 paired with the mobile wireless device 10 by BLE or the like, or an external device communicably connected by another wireless communication method, through communication with the mobile wireless device 10.

In the display content example of FIG. 5, the user interacting with the display is asked “update now?”, and whether to immediately start the update processing of the control software can be selected. This is because, for example, in the example of FIG. 5, about 20 minutes is displayed as the processing time, and the user can determine whether the mobile wireless device 10 is permitted to be unusable for updating the control software during this processing time. This prevents a decrease in usability associated with the control software update. In addition, in a case where it is determined that the required update time calculated by the update information processing unit 110 or acquired from the outside is shorter than a predetermined period of time, the update may be executed without performing the display illustrated in FIG. 5 or notification by other means such as sound or vibration. As an example of the predetermined period of time, it is conceivable to set a time of about 5 minutes in which it is assumed that the mobile wireless device 10 is in a non-wearing state or a non-carried state and the user does not use the mobile wireless device 10.

In addition, in the present embodiment, the information related to the control software update is notified to the user through the mobile wireless device 10. However, according to the determination results up to Step S13, the information indicating that the condition of the update information notification is completed may be transmitted to a mobile terminal such as the smartphone 20 paired with the mobile wireless device 10, and the information related to the control software update may be notified to the user by the mobile terminal, for example.

With reference to the processing flow example of FIG. 4 again, after notifying the user by, for example, display of information related to the update of the control software in Step S14, the update information processing unit 110 returns the processing to step S10, and stands by for the information related to the update of the control software.

The notification processing of the information related to the control software update may be executed at predetermined time intervals. In addition, in the present embodiment, the determination regarding the position range in which the update information notification is possible and the determination regarding the remaining charge amount are also executed, but either of them may be omitted. Alternatively, the notification of the information related to the control software update may be performed based only on whether the mobile wireless device 10 is worn by or carried with the user. Alternatively, the notification of the information related to the control software update may be performed based only on whether the mobile wireless device 10 is within a predetermined updateable range. Alternatively, instead of the mobile wireless device 10 being worn by or carried with the user, the notification of the information related to the control software update may be performed by an acceleration sensor for detecting the swing of the arm of the user based on whether the mobile wireless device 10 is carried (used) by the user. In this case, the mobile wireless device 10 is not limited to a wearable device, and may be various electronic devices such as a smartphone.

In addition, in the present embodiment, the information related to the update is notified immediately when the condition for notifying the information related to the control software update is satisfied. However, the information related to the update may be notified in a case where it is determined that a condition is still satisfied after a predetermined period of time elapses since the condition was satisfied, for example, in order to reliably confirm that the user does not wear or carry the mobile wireless device 10.

In addition, in the present embodiment, the notification regarding the control software update is performed when a condition such as a non-use state in which the user wears or does not carry the mobile wireless device 10 is satisfied. However, it is also possible to perform the control software update without performing the notification to the user when the condition is satisfied.

In the related art, for example, Japanese Unexamined Patent Application, Publication No. 2022-103945 has not taken into consideration that frequent notification of software updates may lead to a decrease in usability. The mobile wireless device 10 according to the present embodiment described above includes the control unit 100 that executes updateable control software, the storage unit 200 that stores at least the control software, the wearing determination unit 120 that detects whether the own device is in a state of being worn on a human body or carried with the human, and the communication unit 400 that performs communication with an external device such as a smartphone. In a case where the wearing determination unit 120 detects that the own device is not worn on the human body or not carried with the human, the control unit 100 makes the processing related to the control software update executable in cooperation with the external device through the communication unit 400.

With such a configuration, it is possible to execute the processing relating to the control software update in a timely manner without impairing the usability of the mobile wireless device 10.

It may be configured such that, in a case where the wearing determination unit 120 detects that the own device is not worn on the human body or carried with the human, the control unit 100 transmits, to the external device via the communication unit 400, non-wearing information (non-carried information) for notifying the external device that the own device is not worn on the human body or carried with the human.

With such a configuration, it is possible to notify the information related to the control software update through the external device such as the smartphone 20.

It may be configured such that, when the wearing determination unit 120 detects that the own device is not worn on the human body or carried with the human, the control unit 100 notifies the information related to the control software update.

With such a configuration, it is possible to notify the user of the information related to the control software update without causing the user to feel bothered while the user does not wear or carry the mobile wireless device 10.

It may be configured such that the control unit 100 enables notification of the information related to the control software update when a predetermined period of time elapses from the time when the wearing determination unit 120 detected that the own device is not worn on the human body or carried with the human.

It may be configured such that the control unit 100 calculates a required time needed for the control software update, and when the wearing determination unit 120 detects that the own device is not worn on the human body or carried with the human, and in a case in which the required time is less than a predetermined update time threshold, the control unit 100 makes the control software update executable.

With such a configuration, it is possible to prevent an unnecessarily long time during which the user cannot use the mobile wireless device 10 due to the control software update.

It may be configured such that the control unit 100 further includes the own device position determination unit 130 capable of acquiring positional information of the own device, and the control unit 100 makes the processing related to the control software update executable in a case where it is determined that the position of the own device acquired by the own device position determination unit 130 is within a predetermined position range set in advance by the user of the mobile wireless device 10, and does not make the processing related to the control software update executable in a case where it is determined that the position of the own device is outside the position range.

With such a configuration, it is possible to prevent the information related to the control software update from being notified when the control software update is inappropriate for execution, for example, when the user is away.

It may be configured such that, in a case where the operation of the GNSS unit 600 serving as the positional information acquisition unit is started, the control unit 100 terminates the operation of the GNSS unit 600 in response to acquisition of at least one point of coordinates corresponding to the positional information of its own device.

With such a configuration, it is possible to suppress the power consumption of the mobile wireless device 10 by the GNSS unit 600 as much as possible.

It may be configured such that the control unit 100 is capable of detecting the remaining amount of charge of the secondary battery provided in the own device, and in a case where the remaining amount of charge of the secondary battery is equal to or more than a predetermined remaining amount threshold, the control unit 100 makes the processing related to the control software update executable.

With such a configuration, it is possible to execute the processing related to the control software update in a case where there is a remaining amount of charge necessary for executing the control software update.

It may be configured such that the wearing determination unit 120 detects whether the own device is in a state of being worn by the user, and in a case where the detection unit detects that the own device is not worn by the user, the control unit makes the processing related to the update of the updatable software executable in cooperation with the external device through the communication unit.

With such a configuration, it is possible to execute the processing relating to the control software update in a timely manner without impairing the usability, particularly for the mobile wireless device 10 having a form of being worn on a human body such as a wristwatch type.

Further, according to the present embodiment, a method of controlling the mobile wireless device 10 is provided. The mobile wireless device 10 includes the control unit 100 that executes updateable control software, the storage unit 200 that stores at least the control software, the wearing determination unit 120 that detects whether the own device is in a state of being worn on a human body or carried with the human, and the communication unit 400 that performs communication with an external device such as a smartphone 20. The method includes, in a case where the wearing determination unit 120 detects that the own device is not worn on the human body or not carried with the human, the control unit 100 making the processing related to the control software update executable in cooperation with the external device through the communication unit 400.

With such a configuration, it is possible to achieve the same advantageous effects as those of the mobile wireless device 10 according to the present embodiment described above.

The present embodiment also includes a program for causing a processor to execute the control method of the mobile wireless device 10.

In the present embodiment described above, as the updatable software, the updatable control software has been described as an example, but the present disclosure is not limited to the control software, and is applicable to all updatable software that is implemented in a wearable device including the mobile wireless device 10 and executed in the wearable device.

The series of processing described above can be executed by hardware or software. In other words, the functional configuration of FIG. 5 is merely an example and is not particularly limited. That is, it is sufficient if the mobile wireless device 10 is provided with a function enabling execution of the above-described series of processing as a whole, and what kind of functional blocks are used to achieve this function is not particularly limited to the example of FIG. 5. In addition, one functional block may be configured by hardware alone, may be configured by software alone, or may be configured by a combination thereof. The functional configuration of the present embodiment is realized by a processor that executes arithmetic processing, and the processor that can be used in the present embodiment includes a processor configured by a single unit of various processing devices such as a single processor, a multiprocessor, and a multicore processor, and a processor in which these various processing devices and processing circuits such as ASIC (Application Specific Integrated Circuit) and FPGA (Field-Programmable Gate Array) are combined.

In addition, in the present specification, the steps describing the program executed by the control unit 100 include not only processing performed in a time series following this order, but also processing performed in parallel or individually without being necessarily performed in a time series.

While embodiments of the present disclosure have been described, these embodiments have been presented by way of example only, and are not intended to limit the scope of the disclosure. The present disclosure can assume various other embodiments, and it is also possible to combine the configurations of the above-described embodiment and modification examples.

Furthermore, various changes such as omissions and substitutions can be made without departing from the gist of the present disclosure. The accompanying claims and their equivalents arc intended to encompass such forms or modifications as would fall within the scope and gist of the invention described in this specification and the like.

What is claimed is:

1. A wearable device comprising:
a processor;
memory;
a sensor that detects whether an own device is in a state of being carried with a user; and
a communication circuit that communicates with an external device, wherein:
the memory stores at least updatable software, and
the processor is configured to
execute the updatable software, and
in a case where the sensor detects that the own device is not in a state of being carried with the user, make processing related to update of the updatable software executable in cooperation with the external device through the communication circuit.

2. The wearable device according to claim 1, wherein, in a case where the sensor detects that the own device is not in a state of being carried with the user, the processor is further configured to transmit non-carried information for notifying the external device that the own device is not in a state of being carried with the user to the external device through the communication circuit.

3. The wearable device according to claim 1, wherein, when the sensor detects that the own device is not in a state of being carried with the user, the processor is further configured to make the processing related to the update of the updatable software executable.

4. The wearable device according to claim 1, wherein, when a predetermined period of time elapses from a time when the sensor detects that the own device is not in a state of being carried with the user, the processor is further configured to make the processing related to the update of the updatable software executable.

5. The wearable device according to claim 1, wherein the processor is further configured to calculate a required time needed for the update of the updatable software, and when sensor detects that the own device is not in a state of being carried with the user and in a case in which the required time is less than a predetermined update time threshold, the processor is further configured to make the processing related to the update of the updatable software executable.

6. The wearable device according to claim 1, wherein the processor is further configured to acquire positional information of the own device, and
in a case where it is determined that a position of the own device is within a predetermined position range set, the processor is further configured to make the processing related to the update of the updatable software executable, and in a case where the position of the own device is outside the position range, the processor is further configured not to make the processing related to the update of the updatable software executable.

7. The wearable device according to claim 6, wherein, in a case where an operation of acquiring the positional information is started, the processor is further configured to terminate the operation of acquiring the positional information in response to acquisition of at least one point of coordinates corresponding to the positional information of the own device.

8. The wearable device according to claim 1, wherein the processor is further configured to detect a remaining amount of charge of a secondary battery provided in the own device, and in a case where the remaining amount of charge of the secondary battery is equal to or more than a predetermined remaining amount threshold, the processor is further configured to make the processing related to the update of the updatable software executable.

9. The wearable device according to claim 1, wherein
the sensor detects whether the own device is in a state of being worn by the user, and
in a case where the sensor detects that the own device is not in a state of being worn by the user, the processor is further configured to make the processing related to the update of the updatable software executable in cooperation with the external device through the communication circuit.

10. A control method for a wearable device executed by a computer including at least one processor, the control method comprising:
executing updatable software;
storing at least the updatable software in memory; and
in a case where a sensor detects that an own device is not in a state of being carried with a user, making processing related to update of the updatable software executable in cooperation with an external device through a communication circuit.

11. The control method for a wearable device according to claim 10, further comprising, in a case where the sensor detects that the own device is not in a state of being carried with the user, transmitting non-carried information for notifying the external device that the own device is not in a state of being carried with the user to the external device through the communication circuit.

12. The control method for a wearable device according to claim 10, further comprising, when the sensor detects that the own device is not in a state of being carried with the user, making the processing related to the update of the updatable software executable.

13. The control method for a wearable device according to claim 10, further comprising, when a predetermined period of time elapses from a time when the sensor detects that the own device is not in a state of being carried with the user, making the processing related to the update of the updatable software executable.

14. The control method for a wearable device according to claim 10, further comprising calculating a required time needed for the update of the updatable software, and when a sensor detects that the own device is not in a state of being carried with the user and in a case in which the required time is less than a predetermined update time threshold, making the processing related to the update of the updatable software executable.

15. The control method for a wearable device according to claim 10, further comprising:
acquiring positional information of the own device, and
in a case where it is determined that an acquired position of the own device is within a predetermined position range set, making the processing related to the update of the updatable software executable, and in a case where the position of the own device is outside the position range, not making the processing related to the update of the updatable software executable.

16. A non-transitory computer-readable storage medium storing a program that is executed by a computer of a wearable device, the program being executable to cause the computer to perform operations comprising:
executing updatable software;
storing at least the updatable software in memory; and
in a case where a sensor detects that an own device is not in a state of being carried with a user, making processing related to update of the updatable software executable in cooperation with an external device through a communication circuit.

17. The non-transitory computer-readable storage medium according to claim 16, wherein the program causes the computer to perform operations further comprising, in a case where the sensor detects that the own device is not in a state of being carried with the user, transmitting non-carried information for notifying the external device that the own device is not in a state of being carried with the user to the external device through the communication circuit.

18. The non-transitory computer-readable storage medium according to claim 16, wherein the program causes the computer to perform operations further comprising, when the sensor detects that the own device is not in a state of being carried with the user, making the processing related to the update of the updatable software executable.

19. The non-transitory computer-readable storage medium according to claim 16, wherein the program causes the computer to perform operations further comprising, when a predetermined period of time elapses from a time when the sensor detects that the own device is not in a state of being carried with the user, making the processing related to the update of the updatable software executable.

20. The non-transitory computer-readable storage medium according to claim 16, wherein the program causes the computer to perform operations further comprising, calculating a required time needed for the update of the updatable software, and when sensor detects that the own device is not in a state of being carried with the user and in a case in which the required time is less than a predetermined update time threshold, making the processing related to the update of the updatable software executable.
